(19) United States
(12) Patent Application Publication
(10) Pub. No.: US 2025/0243908 A1
(43) Pub. Date: Jul. 31, 2025

(54) COOLED AERODYNAMIC THRUST BEARING AS WELL AS TURBOCOMPRESSOR WITH SUCH A THRUST BEARING

(71) Applicant: ebm-papst Mulfingen GmbH & Co. KG, Mulfingen (DE)

(72) Inventor: Mihai B. DOBRICA, Heidelberg (DE)

(21) Appl. No.: 19/042,082

(22) Filed: Jan. 31, 2025

(30) Foreign Application Priority Data
Jan. 31, 2024 (DE) 102024102694.4

(51) Int. Cl. F16C 37/00; F16C 17/04

(52) U.S. Cl. CPC F16C 37/002; F16C 17/04; F16C 2360/44

(57) ABSTRACT

A cooled aerodynamic thrust bearing for axially mounting a shaft for a turbocompressor extending along an axis of rotation A, having two annular thrust bearing washers arranged concentrically with respect to the axis of rotation, wherein the two thrust bearing washers are spaced apart in the axial direction by a spacer washer and form a cavity between them in the axial direction for receiving a shaft sleeve connected to the shaft. The spacer washer extends beyond the thrust bearing washers in the radial direction and is formed to maintain the thrust bearing washers at a predetermined axial distance by means of an annular, radially inner section, and to dissipate heat from the cavity and/or from the thrust washers radially outwards by means of an annular, radially outer cooling section formed as a heat sink.

### RELATED APPLICATIONS

This application claims priority to German Patent Application No. 10 2024 102 694.4, filed Jan. 31, 2024, the entire contents of which is incorporated herein by reference in its entirety.

### FIELD

The disclosure relates to a cooled aerodynamic thrust bearing for axially mounting a shaft for a turbocompressor extending along an axis of rotation as well as to a turbocompressor with such a bearing, being in particular an oil-free high-speed turbocompressor.

### BACKGROUND

Aerodynamic bearings, which are also referred to as aerostatic bearings or air bearings, as well as their use in turbocompressors are known in the art, wherein turbocompressors may be formed, for example, as axial, radial, or diagonal compressors, and radial compressors, in particular, may also be referred to as centrifugal compressors or radial-flow compressors.

The basic principle of action of such aerodynamic bearings is that the bearing partners are separated by a thin gas film or a thin gas cushion, respectively, so that a stick-slip-free and friction-free movement with great accuracy is enabled between the bearing partners.

In relation to turbocompressors, both axial mounting and radial mounting of an impeller of the compressor or a shaft, respectively, for receiving the impeller are preferably realized by aerodynamic bearings.

For this purpose, a shaft sleeve is usually provided on the shaft, which is connected to the shaft in a rotationally fixed manner and is arranged between two thrust bearing washers in order to form the axial mounting.

In this respect, it is problematic that, despite the friction-free mounting on the thrust bearing washers, disadvantageous heat development may occur, which is highly problematic, in particular in turbocompressors in cooling applications, since this would, for example, cause additional heat to be introduced into a cooling fluid conveyed or compressed, respectively, by the turbocompressor.

In relation to continuous-flow machines, in general, DE 10 2021 203 593 A1 proposes, for example, to cool the thrust bearing washers directly through a cooling duct which is each adjacent to or formed in the respective thrust bearing washer. In this respect, however, it is disadvantageous that the plurality of cooling ducts requires complex sealing and complex fluid routing. Additionally, in relation to cooling ducts provided directly in the thrust bearing washers, the ducts structurally weaken the washers or increase their installation space requirement, as a result of which they deform more easily during operation and thus interfere with the mounting or may be significantly more complex and expensive to manufacture.

Furthermore, DE 10 2021 203 593 A1 also proposes to form a cooling duct within a spacer washer, by means of which the thrust bearing washers are held at a predetermined distance from one another. However, this also has several disadvantages, since, on the one hand, the structure is once again weakened and, on the other hand, sealing directly against the thrust bearing washers becomes necessary, as a result of which the necessary exactly parallel arrangement of the thrust bearing washers relative to one another on the spacer washer is made more difficult.

### BRIEF SUMMARY

The present disclosure overcomes the aforementioned disadvantages and provides an aerodynamic bearing for axially mounting a shaft, in particular of a turbocompressor, by means of which cost-effective mounting of the shaft can be achieved with good cooling or good dissipation of heat arising on the bearing, respectively.

According to the disclosure, a cooled aerodynamic thrust bearing for axially mounting a shaft extending along an axis of rotation is proposed, which may in particular be the shaft of a turbocompressor, which furthermore is provided, in particular, for cooling applications, in which a cooling fluid is thus conveyed or compressed by the turbocompressor, respectively. The thrust bearing proposed according to the disclosure has two annular thrust bearing washers arranged concentrically with respect to the axis of rotation and to each other, respectively. Furthermore, the two thrust bearing washers are spaced apart in the axial direction by a spacer washer, which is arranged in particular directly on the thrust bearing washers or abuts them, respectively, so that the thrust bearing washers on the spacer washer can be aligned parallel to one another and orthogonally to the axis of rotation and can be held at a predetermined axial distance from one another by the spacer washer. The spacer washer may also be referred to as a spacer ring, wherein the sections described in the following are each preferably annular on the spacer washer or the spacer ring, respectively. In the axial direction, correspondingly, this forms a cavity between the thrust bearing washers for receiving a shaft sleeve connected to the shaft, wherein the shaft sleeve may also be referred to as a shaft collar. Furthermore, the shaft sleeve or the shaft collar, respectively, may be fixed to the shaft or formed by the shaft. Preferably, each of the thrust bearing washers correspondingly has a thrust bearing surface facing the cavity, which forms the bearing partner for a respective bearing surface provided on the shaft sleeve. In order to now be able to dissipate heat arising in the cavity or on the thrust bearing washers, respectively, or to be able to cool the thrust bearing, respectively, it is provided according to the disclosure that the spacer washer extends beyond the thrust bearing washers in the radial direction, i.e. radially outwards beyond the thrust bearing washers, and is formed to maintain the thrust bearing washers at a predetermined axial distance by means of an annular, radially inner section, and to dissipate heat from the cavity and/or from the thrust washers radially outwards by means of an annular, radially outer cooling section formed as a heat sink.

In contrast to known solutions, in this respect, it is not necessary to seal the thrust bearing washers against the spacer washer nor to structurally weaken any of these components.

Within the scope of the present description, the axial direction, the radial direction and the circumferential direction refer to the axis of rotation, unless otherwise indicated in the specific case.

Furthermore, it is also provided according to one variant that the spacer washer has at least one annular, i.e. circumscribing the axis of rotation in an annular manner, sealing section in the radial direction between the radially inner section and the cooling section, in which the spacer washer is formed to abut both sides of a respective, in particular flexible, sealing body in the axial direction, wherein, for the avoidance of doubt, it may be provided that the sealing section is in particular provided to be spaced from the thrust bearing washers, so that the sealing section does not negatively affect the alignability of the thrust bearing washers with the spacer washer nor the function of the spacer washer.

Preferably, in the axial direction, the spacer washer thus abuts a first sealing body at a first side and a second sealing body on an opposite second side, so that a fluid-tight seal is realized against both sides of the spacer washer.

Further, the aerodynamic thrust bearing preferably has a bearing housing featuring a first housing section and a second housing section, preferably each being formed as a housing part or a housing shell, respectively. The first housing section or the first housing part, respectively, and the second housing section or the second housing part, respectively, each have a sealing region, each formed to abut the spacer washer or the sealing section of the spacer washer, respectively, via a respective sealing body and to separate a radially inner thrust bearing space thereby formed by the bearing housing from a radially outer cooling space in a fluid-tight manner.

Furthermore, the first housing section or the first housing part, respectively, and the second housing section or the second housing part, respectively, may each have a clamping region formed to, in particular, directly abut a respective thrust washer and to press the two thrust washers as well as the spacer washer arranged with the radially inner section therebetween against one another in the axial direction and to fix them correspondingly in their orientation and arrangement.

Furthermore, the housing sections or the housing parts, respectively, can be formed to limit the cooling space together with the cooling section of the spacer washer in its circumferential direction.

It is generally the case that the cooling space, which may also be referred to as the cooling duct, is preferably formed to circumscribe the axis of rotation in a concentric manner and substantially completely, so that the thrust bearing can be cooled uniformly and efficiently over its entire circumference.

Correspondingly, a development provides for the cooling space to circumscribe the axis of rotation in an annular manner, to enclose the cooling section of the spacer washer, and to be formed for a cooling fluid to flow therethrough, so that heat generated at the thrust bearing washers or in the cavity, respectively, may be directed via the spacer washer into the cooling space and there be dissipated by means of the cooling fluid.

Further, the aerodynamic thrust bearing may have the sealing bodies possessing a predetermined elasticity and formed in particular as sealing rings arranged concentrically with respect to the axis of rotation. In this respect, the housing sections or housing parts, respectively, are formed over their respective sealing regions and the elasticity of the sealing bodies is selected in such a way that the thrust bearing space and the cooling space are sealed against one another in a fluid-tight manner without deformation of the spacer washer. As the spacer washer is not deformed and, in particular, is not warped or curved, the alignment of the thrust bearing washers remains unaffected.

Preferably, the first housing section and the second housing section are sealed against one another radially outward of the cooling space by a further sealing body which may be formed in particular as a further sealing ring arranged concentrically with respect to the axis of rotation.

In order to be able to align the spacer washer concentrically with respect to the axis of rotation in an easy manner upon assembly of the thrust bearing, the spacer washer may be provided to have at least one positioning aid extending in the axial direction and/or extending in the radial direction for concentrically aligning the spacer washer with respect to the axis of rotation. Such a positioning aid may be formed, for example, as at least one projection extending in the axial direction or radial direction, which may be supported on one of the housing sections and thereby establish the positioning of the spacer washer with respect to the housing.

As previously mentioned, it is preferably provided that the two thrust bearing washers each have a thrust bearing surface facing the cavity for forming a respective axial gas cushion in a respective thrust bearing gap between the respective thrust bearing surface and the shaft sleeve for axially mounting the shaft.

In this respect, the shaft sleeve, which may also be referred to as a shaft collar, may be fixed to the shaft by at least one fastener, may be formed integrally by the shaft, and/or may be formed as one piece with the shaft.

In order to improve cooling, the spacer washer may also form or have cooling ribs or other cooling elements on its cooling section, where increased heat may be released when the cooling fluid flows around the spacer washer in the cooling space.

In relation to the axis of rotation, the spacer washer is also preferably formed to be rotationally symmetric or point-symmetric.

A further aspect of the disclosure relates to a turbocompressor with an aerodynamic thrust bearing proposed according to the disclosure, wherein the turbocompressor may be formed as a radial, axial, or diagonal compressor. The aerodynamic thrust bearing has a bearing housing with a first housing section and a second housing section. The first housing section and the second housing section of the bearing housing each have a sealing region, each formed to abut the spacer washer via a respective sealing body and to separate a radially inner thrust bearing space thereby formed by the bearing housing from a radially outer cooling space in a fluid-tight manner. In this respect, the turbocompressor is provided to have an at least two-part inner housing for receiving a shaft extending along an axis of rotation as well as, preferably, for receiving a motor driving the shaft, wherein a first part of the inner housing forms the first housing section of the bearing housing, and a second part of the inner housing forms the second housing section of the bearing housing. Bearing housings and the inner housing of the turbocompressor are thus formed integrally with one another.

In such a turbocompressor, it may also be provided that the shaft or an impeller arranged on the shaft is formed to generate a fluid flow of the cooling fluid flowing through the cooling space defined by the inner housing.

Further, the shaft or an impeller arranged on the shaft may be formed to compress a cooling fluid, wherein the cooling fluid is the cooling fluid flowing through the cooling space.

The features disclosed above can be combined as required, provided this is technically possible and they do not contradict one another.

### BRIEF DESCRIPTION OF THE DRAWINGS

Other advantageous developments of the disclosure are characterized in the subclaims and/or depicted in greater detail below together with the description of the preferred embodiment of the disclosure with reference to the figures. In the drawings:

FIG. 1 shows a two-dimensional sectional view of an aerodynamic thrust bearing;

FIG. 2 shows a perspective sectional view of an aerodynamic thrust bearing.

### DETAILED DESCRIPTION

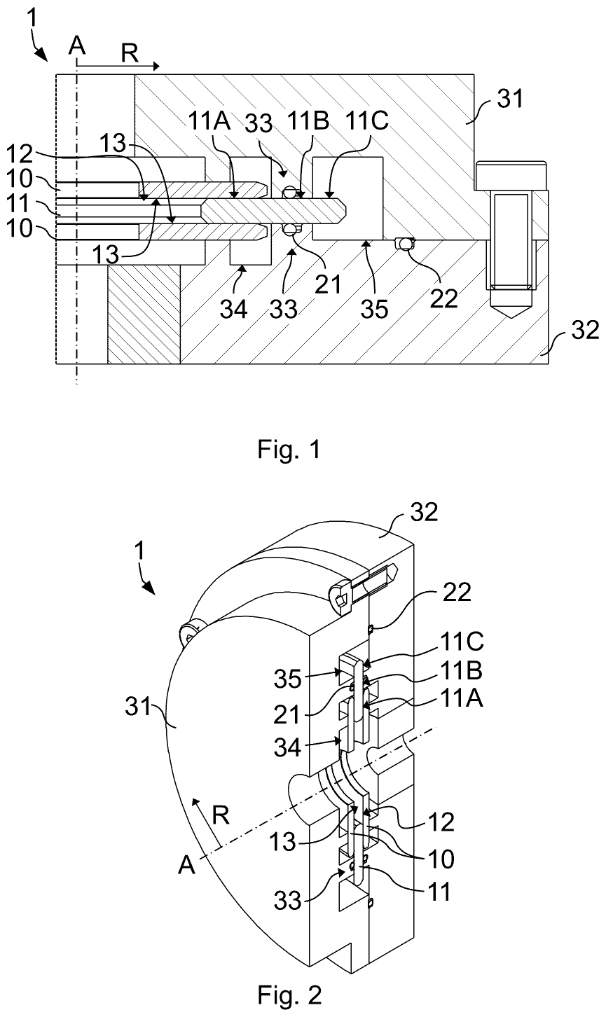

The figures are schematic by way of example and each represent a cooled aerodynamic thrust bearing 1 in a sectional view, wherein only a part of the thrust bearing 1 is depicted in FIG. 1. Same reference symbols in the figures indicate same functional and/or structural features, such that individual features do not have to be described for each figure.

For mounting a shaft, not shown, the cooled aerodynamic thrust bearing 1 has two thrust bearing washers 10 extending in an annular manner about an axis of rotation A of the shaft, as well as a spacer washer 11 arranged therebetween and maintaining the thrust bearing washers 10 at a predetermined axial distance, such that a cavity 12 which is delimited radially outwards by the spacer washer 11 is formed along the axis of rotation A between the thrust bearing washers 10.

It is very preferred in this regard that the spacer washer 11 extends beyond the thrust bearing washers 10 in the radial direction R and is formed to simultaneously maintain the thrust bearing washers 10 at the predetermined distance by means of a radially inner section 11A circumscribing the axis of rotation A in an annular manner, and dissipate heat from the cavity 12 and/or from the thrust bearing washers 10 at a cooling section 11C circumscribing the axis of rotation A in an annular manner.

In this respect, the thrust bearing washers 10 and spacer washer 11 are held in a housing having two housing sections 31, 32, wherein the housing sections 31, 32 each have sealing regions 33 which act via a sealing body 21 lying therebetween and formed as an O-ring or sealing ring, respectively, on a sealing section 11B of the spacer washer 11, such that a sealing plane is formed at the sealing section 11B lying between the radially inner section 11A and the cooling section 11C. Consequently, a radially inner thrust bearing space 34 of the housing can be separated in a fluid-tight manner from a radially outer cooling space 35, such that fluid flows around the cooling section 11C of the sealing washer 11 arranged in the cooling space 35 and the heat can be transported away.

Since the sealing regions 33 are coordinated with the sealing bodies 21 so as not to deform the sealing section 11B and the entire spacer ring 11, respectively, the thrust bearing washers 10 and their bearing surfaces 13 facing the cavity 12 are held exactly in the desired position and are simultaneously cooled.

For further sealing of the cooling space 35, a further sealing body 22 is provided radially outside, which is provided directly between the housing sections 31, 32 and seals them against one another.

The disclosure is not limited in its execution to the abovementioned preferred exemplary embodiments. Rather, a number of variants are conceivable which make use of the illustrated solution even in the form of fundamentally different embodiments.

1. A cooled aerodynamic thrust bearing for axially mounting a shaft for a turbocompressor extending along an axis of rotation, the aerodynamic thrust bearing comprising:
a bearing housing with a first housing section and a second housing section, and
two annular thrust bearing washers arranged concentrically with respect to the axis of rotation,
wherein the two thrust bearing washers are spaced apart in the axial direction by a spacer washer and form a cavity between them in the axial direction for receiving a shaft sleeve connected to the shaft, and
wherein the spacer washer extends beyond the thrust bearing washers in the radial direction and is formed to maintain the thrust bearing washers at a predetermined axial distance by means of an annular, radially inner section, and to dissipate heat from the cavity and/or from the thrust washers radially outwards by means of an annular, radially outer cooling section formed as a heat sink
wherein the first housing section and the second housing section each have a sealing region, each formed to abut the spacer washer via a respective sealing body and to separate a radially inner thrust bearing space formed by the bearing housing from a radially outer cooling space in a fluid-tight manner,
wherein the cooling space circumscribes the axis of rotation in an annular manner, encloses the cooling section of the spacer washer, and is configured for a cooling fluid to flow therethrough.

2. The aerodynamic thrust bearing according to claim 1,
wherein the spacer washer has at least one annular sealing section in the radial direction between the radially inner section and the cooling section, in which the spacer washer is formed to abut both sides of a respective sealing body in the axial direction.

3. The aerodynamic thrust bearing according to claim 1,
further comprising the sealing bodies having a predetermined elasticity and formed in particular as sealing rings arranged concentrically with respect to the axis of rotation,
wherein the housing sections are formed over their respective sealing regions and an elasticity of the sealing bodies is selected in such a way to seal the thrust bearing space and the cooling space against one another without deformation of the spacer washer.

4. The aerodynamic thrust bearing according to claim 1,
wherein the first housing section and the second housing section are sealed against one another radially outward of the cooling space by a further sealing body which is formed as a further sealing ring arranged concentrically with respect to the axis of rotation.

5. The aerodynamic thrust bearing according to claim 1,
wherein the spacer washer has at least one positioning aid extending in the axial direction and/or extending in the radial direction for concentrically aligning the spacer washer with respect to the axis of rotation.

6. The aerodynamic thrust bearing according to claim 1,
wherein the two thrust bearing washers each have a thrust bearing surface facing the cavity for forming a respective axial gas cushion in a respective thrust bearing gap between the respective thrust bearing surface and the shaft sleeve for axially mounting the shaft.

7. A turbocompressor with an aerodynamic thrust bearing configured according to claim 1, the turbocompressor further comprising:
an at least two-part inner housing for receiving a shaft extending along an axis of rotation,
wherein a first part of the inner housing forms the first housing section of the bearing housing, and a second part of the inner housing forms the second housing section of the bearing housing.

8. The turbocompressor according to claim 7,
wherein the shaft or an impeller arranged on the shaft is formed to generate a fluid flow of the cooling fluid flowing through the cooling space, and/or
wherein the shaft or an impeller arranged on the shaft is formed to compress a cooling fluid, wherein the cooling fluid is the cooling fluid flowing through the cooling space.

9. The aerodynamic thrust bearing according to claim 2, wherein the sealing body is flexible.
